(19) United States
(12) Patent Application Publication
(10) Pub. No.: US 2005/0006181 A1
(43) Pub. Date: Jan. 13, 2005

(54) Gravity potential powered elevator

(76) Inventor: Kwan-Chul Lee, Princeton, NJ (US)

Correspondence Address: Kwan-Chul Lee, 702 Lakeview Terrace, Princeton, NJ, 08540, US

(21) Appl. No.: 10/610,166

(22) Filed: Jun. 30, 2003

(51) Int. Cl. B66B 9/02

(52) U.S. Cl. 187/270; 187/281

(57) ABSTRACT

An elevator system using a variable gearbox(28) and a feedback control(30) for the generation of driving force in up and down directions from the potential difference of the load(12) and the counterweight(10). The invention connects load and counterweight by a feedback controlled variable gearbox. The operation of the invention is consist of three steps: first, measuring the weight of load, second, setting the initial rate of the variable gearbox using the weight information so that enough amount of gravitational force can act in the desired direction, then the car will move at a constant acceleration, third, controlling the rate of the variable gearbox using the signal from the position sensor(32) in order to optimize the speed and position of the car. The invention will get rid of the main driving motor and reduce a lot of energy consumption.

### CROSS-REFERENCE TO RELATED APPLICATIONS

A: U.S. Pat. No. 4,766,977, Yamasaki, Aug. 30, 1988

B: U.S. Pat. No. 6,450,299, Lysaght, Sep. 17, 2002

C: U.S. Pat. No. 5,828,014, Coto, Oct. 27, 1998

D: U.S. Pat. No. 6,526,368, Coste, Feb. 25, 2003

### FEDERALLY SPONSORED RESEARCH

Not Applicable

### SEQUENCE LISTING OR PROGRAM

Not Applicable

### BACKGROUND OF THE INVENTION—FIELD OF INVENTION

This invention relates to new energy saving type elevators, specifically to such elevators that use the gravity as the driving force.

### BACKGROUND OF THE INVENTION

(1) Prior Art

Most of the modern electric elevators utilize the counterweight as a balancing weight for the reduction of the driving force but the load weight varies with number of passengers or amount of load so the mass difference between load weight and counterweight is inevitable. Therefore the mechanism of a conventional electric elevator always uses additional driving device such as electric motor to move the elevator car upward or downward. This electric motor transforms the form of energy from electricity to gravity potential. During this process a large magnitude of energy loss occurs because of the limited efficiency of the motor. For the energy saving of the elevator system the permanent magnet DC motors were developed to replace low efficient induction motors and the vector inverters were applied for the motor control. But the high cost of the permanent magnet DC motor and vector inverter is an obstacle for the application and the energy consumption of the motors still remained.

(2) Objects and Advantages

This invention utilizes a novel technology of continuously variable transmission and modern feedback control for the direct driving of the elevator car from the gravity potential of the load and counterweight. Its object is to remove the energy consumption of the electric motor in the elevator system. It operates without the main driving motor since its driving force comes from the gravity potential energy. So its main advantage is energy saving of driving motor. And an additional advantage is that it can be used as a method of diurnal load leveling which stores residual energy during midnight and restores it during daytime when electricity demand peaks.

### SUMMARY

The gravity powered elevator compromises a variable gearbox with gear changing actuator, an automated clutch and a feedback control circuit with a weight sensor and a position sensor. Before the elevator car starts the weight sensor measures the load weight and according to this weight information the feedback control circuit sends output signal to the gear changing actuator to set the rate of variable gearbox properly. As the elevator car moves the position sensor continuously sends the signal of the position and speed of the elevator car. And the feedback control unit maintains the optimized speed and position of the elevator car by the control of variable gearbox. For the compensation of the energy loss by friction the energy compensation unit periodically elevates the counterweight.

### DRAWINGS—FIGURES

FIG. 1 shows the overall diagram of the gravity powered elevator system.

FIG. 2 shows the moving mechanism during the ascending.

FIG. 3 shows the moving mechanism during the descending.

FIG. 4 shows the block diagram of the feedback control of the gravity powered elevator system.

### DRAWINGS—REFERENCE NUMERALS

10 counterweight

12 elevator car (load)

14 pulley for counterweight rope

16 reducing gear set for counterweight side

18 pulley for load rope

20 reducing gear set for load side

22 automated clutch box

24 friction loss compensation unit

26 actuator for rate change of variable gearbox

28 variable gearbox

30 feedback control unit

32 position sensor of elevator car

34 weight sensor of load

### DETAILED DESCRIPTION

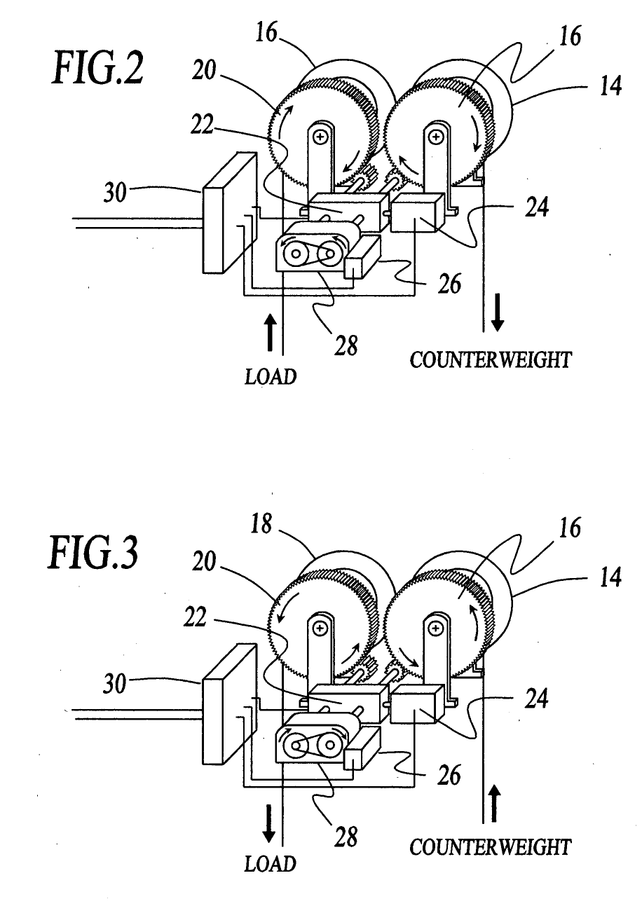

The principle of the invention is same as the principle of lever. One can give a simplified explanation as follow. When the load weight is heavier than counterweight 10 and the elevator 12 is heading upward, the gear rate should be set at a ratio as shown in the FIG. 2 so that the smaller gravity force of counterweight can drive the gearbox 28 and the elevator can move upward. On the other hand when the counterweight is heavier than load and the elevator is heading downward, the gear rate should be set at a ratio as shown in the FIG. 3 so that the smaller gravity force of load weight can drive the gearbox and the elevator can move downward. Opposite cases of these two examples are easier to understand because in those cases larger gravity forces drive the gearbox and load. One of important parts in this system is the feedback control of the variable gearbox because after the initial movement of the elevator it will move at a constant acceleration.

The real weight of counterweight should be heavy enough since it also has a role of the energy storage. The initial position of the counterweight must be higher than the position after appropriate operation period because the descending of the counterweight during the operation due to the friction loss must be in the range of elevator height.

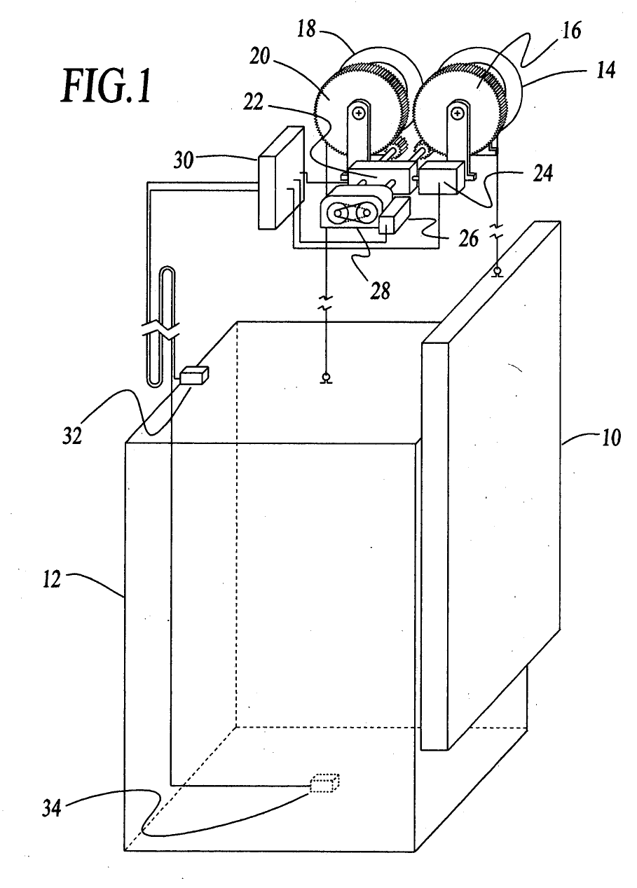

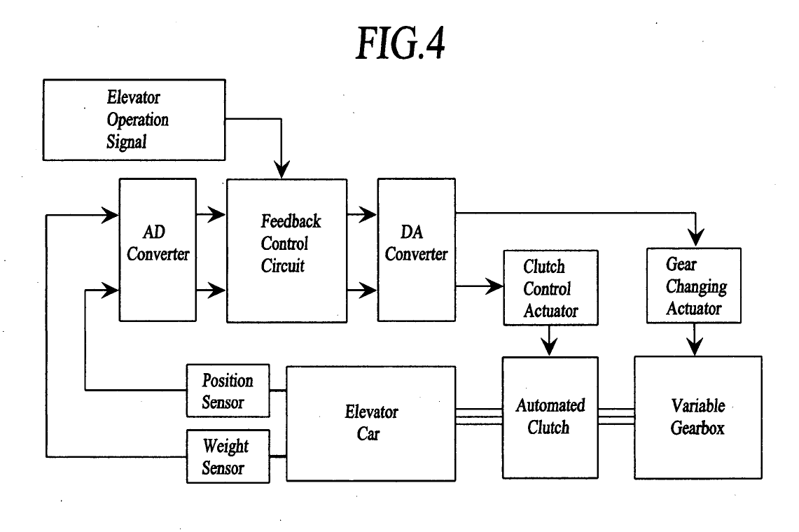

The detailed operation scheme of the gravity powered elevator can be described as follows. After all the passengers are get in the elevator car and the counterweight position is fixed by a brake then the automated clutch shown in the FIG. 1 as 22 disconnects the transmission so that the bottom of elevator car supports full weight of load and the weight sensor 34 can measure the load weight. This weight information goes to the feedback control circuit through the AD converter shown in the FIG. 4 with combining the information of the destination produced by the elevator buttons shown in the FIG. 4 as the elevator operation signal, the feedback control circuit produces pertinent output signal for the gear changing actuator so that the initial setting of the variable gearbox can take place. After the initial setting of the gearbox the clutch reconnects the transmission and the brake releases the counterweight. The elevator will move to the desired direction from this moment at a constant acceleration. After the start of the elevator movement the position sensor 32 sends the information of the position and speed of the elevator to the feedback control unit 30. The feedback control circuit produces transient output signal for the gear changing actuator 26 from those signals of position sensor and destination information. The operational plan of the elevator speed for each combination of destinations to be programmed in the feedback control circuit so that all of the translations from one floor to another can be optimized.

In principle the invention doesn't need additional driving apparatus such as electric motor because it is driven by the gravity potential force of load and counterweight but there should be finite amount of friction loss during the operation. Due to this friction loss after long operation time the rope distance between load and counterweight becomes longer than initial state and the position of counterweight descends to lower level. This means the energy consumption by the friction is supplied from the gravity potential of the counterweight. Therefore energy compensation needs after appropriate period of system operation. 24 of FIG. 1, the friction loss compensation unit that can be consist of either electric motor or motor-generator set with battery is for the elevation of counterweight. The time interval and frequency of elevator operations between friction loss compensations are dependent on the efficiency of the system so the optimum design of the counterweight and the component of friction loss compensation unit such as the power of electric motor can be determined by the efficiency consideration. The higher the efficiency the longer the time interval can be and if this time interval is long enough one can arrange the friction loss compensation schedule once a day during the midnight when the electricity cost is low. Then this invention can be a method for the diurnal load leveling.

Definitely the main purpose of this invention is energy saving. As indicated above the elimination of the main driving motor will reduce lots of energy consumption because the conventional electric elevator also has the friction loss. The FIG. 1 included two sets of speed reducing gears 16, 20 between the rope pulleys 14, 18 and automated clutch which reduces the force exerting on the variable gearbox and increases the speed of gear rotation. If very strong continuous variable transmission gearboxes with slow speed are available one can get rid of these speed reducing gear sets from the system. The modern electric elevators have evolved to replace the induction motors by permanent magnet DC motors and vector inverters in order to reduce the energy consumption up to 50%. The gravity potential powered elevator will replace the expensive DC motor and vector inverter by the variable gearbox and feedback control and remove most of the energy consumption remained.

1. An elevator system with the driving force generated by the gravity potential of load and counterweight in both up and down directions comprising a variable gearbox, a weight sensor, a position sensor, a feedback control unit and a friction loss compensation unit.

2. An elevator system according to claim 1, characterized in that the rate of said variable gearbox can be adjusted by an automated gear changing actuator.

3. An elevator system according to claim 1, characterized in that said variable gearbox is of the continuous variable transmission gearbox type

4. An elevator system according to claim 1, characterized in that said variable gearbox is of the discrete speed gearbox type.

5. An elevator system according to claim 1, characterized in that said variable gearbox is a combination of said continuous variable transmission gearbox type and said discrete speed gearbox type.

6. An elevator system according to claim 1, characterized in that there are separate rope pulleys for each said load and said counterweight connected to said variable gearbox.

7. An elevator system according to claim 1, characterized in that said separate rope pulleys are connected to said variable gearbox by the automated clutch.

8. An elevator system according to claim 1, characterized in that said separate rope pulleys are connected to said variable gearbox by the speed reducing gear sets.

9. An elevator system according to claim 1, characterized in that there is said automated clutch between said speed reducing gear sets and said variable gearbox.

10. An elevator system according to claim 1, characterized in that the initial setting of said variable gearbox is performed by said feedback control unit consists of said gear changing actuator, a load weight sensor and a feedback control circuit.

11. An, elevator system according to claim 1, characterized in that the transitional setting of said variable gearbox is performed by said feedback control unit that is consist of said gear changing actuator, a car position sensor and said feedback electronic circuit.

12. An elevator system according to claim 1, characterized in that said friction loss compensation unit is consist of a motor actuator.

13. An elevator system according to claim 1, characterized in that said friction loss compensation unit is consist of a motor-generator set and a battery.

14. An elevator system characterized as a method of diurnal load leveling since the main power consumption for the friction loss occurs at midnight.
